(19) United States
(12) Patent Application Publication
(10) Pub. No.: US 2009/0071970 A1
(43) Pub. Date: Mar. 19, 2009

(54) Beverage container

(76) Inventors: Michael Sultana, Greenfield Park (AU); Rhys Sultana, Greenfield Park (AU)

Correspondence Address: D. PETER HOCHBERG CO. L.P.A., 1940 EAST 6TH STREET, CLEVELAND, OH, 44114, US

(21) Appl. No.: 12/283,842

(22) Filed: Sep. 16, 2008

(30) Foreign Application Priority Data
Sep. 16, 2007 (AU) 2007905002

(51) Int. Cl. B65D 5/46; B23P 11/00

(52) U.S. Cl. 220/772; 29/428

(57) ABSTRACT

A beverage container or drinking vessel that can be easily held by a person without the need to grip the container comprising a body member having a circumferential sidewall and a base with a substantially flat bottom surface. The beverage container comprises first and second handle members. The first handle member protrudes from the sidewall and is adapted to engage with a first portion of a user's hand. The second handle member that is spaced apart from the first handle member and also protrudes from the sidewall is adapted to engage with a second portion the user's hand.

### CROSS-REFERENCE TO RELATED APPLICATION

This application claims foreign priority based on Australian Patent Application Serial No. 2007905002 filed Sep. 16, 2007, the content of which is incorporated herein by reference in its entirety.

### BACKGROUND OF THE INVENTION

1. Field of the Invention

The present invention relates to a beverage container or drinking vessel that can be easily held by a person without the need to grip the container. In particular, the present invention relates to a cup or mug that can be held by a person having a disability, medical condition or other fine motor skills impairment, without the need for dexterous gripping of the mug or cup.

2. Description of the Prior Art

For people with mobility disabilities or impairments, it can often be very difficult for them to undertake simple tasks that require dexterous motor skills. Typical afflictions that can result in the loss or diminishment of fine motor skills include arthritis, upper back and neck injuries, stroke, spinal injuries and other severe trauma caused by accidents, particularly involving motor vehicles.

The diminishing of the independence of people affected by such motor skill impairments can often lead to frustration on their behalf and decrease their quality of life. One simple task that can become an arduous, or even impossible in some cases, is the use of a drinking container, such as a mug or cup for drinking beverages. It is particularly problematic where the beverage is a hot drink, such as tea, coffee or the like that can cause severe burns to the person in the event that the beverage is spilt on them.

Also, as defined by the second law of thermodynamics, which states that the total entropy of any isolated thermodynamic system tends to increase over time, approaching a maximum value, where the cup or mug contains a hot beverage, such as tea or coffee, the sides of the cup or mug will become hot to the touch. Often, by the time the cup or mug has sufficiently cooled down to allow a person to comfortably touch the side of the container, the hot beverage contained in the mug has also cooled to a point where it is no longer pleasant to drink.

There have been previous attempts to provide a beverage container that can be used comfortably by people with diminished or impaired fine motor skills. However, most of these conventional products provide a beverage container that requires the person using the cup to use two hands to pick up the container and bring it to their lips to drink the beverage. One example of this prior art style of double handled beverage vessel is the “Thumbs Up” cup, which is manufactured by the Hoffman Group. The “Thumbs Up” cup is a twin handle cup with a thumb rest above each handle that provides stability and easy lifting for both children and adults with fine motor skills impairments.

One major drawback of these prior art double handled style beverage containers is the fact that the person using the container must use two hands to enjoy the benefits of the easy grip nature of the container. For this reason, people who may have limited movement in only one of their arms and hands will not likely be able to use such a double handled cup without assistance. Also, because these double handled cups are commonly used by young children, there is some degree of a stigma associated with using this style of beverage vessel as an adult. For many people with a disability, one of their main priorities is the assimilation into society, without drawing unnecessary attention to themselves or their disability. Therefore, the use of a double handed cup, commonly used by children, does not assist with their assimilation into general society. On a more basic level, it can be inconvenient to have to use two hands to drink from a beverage container, particularly when the person's other hand is simultaneously needed for another task, such as reading a book, newspaper or the like, eating food or some other task.

It would therefore be an advantage if a drinking vessel or beverage container can be provided that would overcome at least some of the disadvantages of previously known beverage containers, or would provide a useful alternative to these.

### SUMMARY OF THE INVENTION

According to a first aspect of the present invention there is provided a beverage container comprising a body member having a circumferential sidewall and a base with a substantially flat bottom surface; a first handle member protruding from the sidewall adapted to engage with a first portion of a user's hand; and a second handle member spaced apart from the first handle member and protruding from the sidewall adapted to engage with a second portion the user's hand.

Preferably, the second handle member is adapted to engage with a portion of the user's thumb. The second handle member can be at any angle between 0° and 180° relative to the base.

Preferably, the first and second handle portions further include thermal insulating material to minimize heat transfer between the body member and the user's hand. The thermal insulating material is preferably a heat insulation pad having a plurality of heat transfer ridges. It is preferred that the sidewall of the body member includes a plurality of the heat insulation bars projecting therefrom. The each of plurality of heat insulation bars are located on the sidewall so as to prevent contact between the user's hand and the sidewall of the body member.

Preferably, the body member is substantially of one or more of food grade metal, plastic, ceramic, glass or clay.

According to a second embodiment of the present invention there is provided a method of retrofitting a support aid to a beverage container comprising a body member having a circumferential sidewall, a base and a first handle member protruding from the sidewall, said first handle portion being adapted to engage with a first portion of a user's hand, said method comprising the steps of fixing a second handle member to the sidewall of the body member, said second handle member adapted to be fixedly engaged with the sidewall at a location spaced apart from the first handle member, wherein said second handle member is adapted to engage with a second portion the user's hand.

Preferably, the second handle member includes thermal insulating material to minimize heat transfer between the body member and the second portion of the user's hand. The second handle portion is adapted to be adhered to the sidewall of the body. Preferably, the second handle portion is adapted to engage with a portion of the user's thumb.

### BRIEF DESCRIPTION OF THE DRAWINGS

The invention will now be described, by way of example only, with reference to the accompanying drawings, where:

FIG. 1 depicts a side view of a beverage container in accordance with a first embodiment of the present invention;

FIG. 2 depicts a top view of the beverage container shown in FIG. 1;

FIG. 3 depicts a side view of the beverage container shown in FIG. 1 with thermal insulating material attached thereto;

FIG. 4 depicts a side view of a beverage container in accordance with a second embodiment of the present invention;

FIG. 5 depicts a side view of the beverage container shown in FIG. 3 with additional thermal insulating material attached thereto;

FIG. 6 depicts a top view of the beverage container shown in FIG. 5;

FIG. 7 depicts a side view of a beverage container in accordance with a third embodiment of the present invention;

FIG. 8 depicts a side perspective view of a beverage container in accordance with a fourth embodiment of the present invention; and

FIG. 9 depicts a perspective view of a support aid in accordance with the present invention, adapted to be retrofit to a conventional beverage container.

### DETAILED DESCRIPTION OF THE PREFERRED EMBODIMENTS

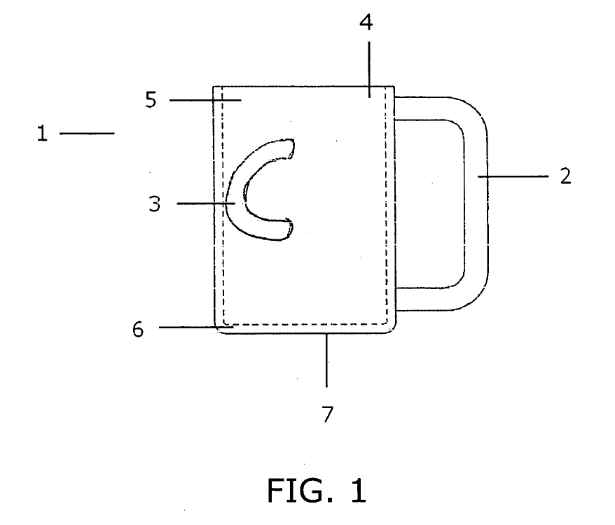

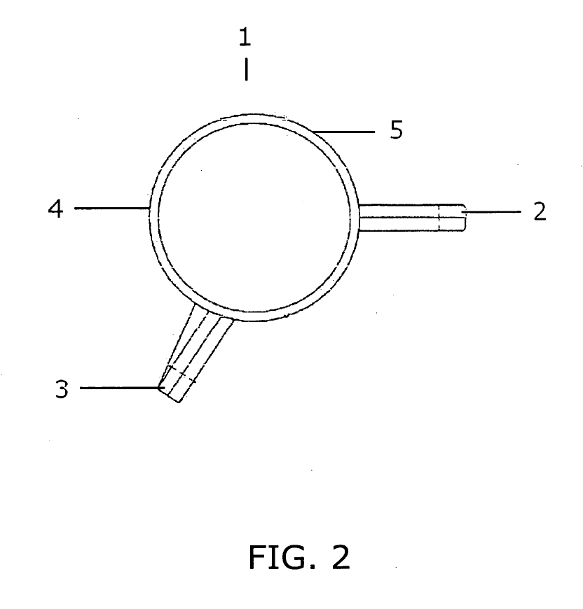

The present invention generally relates to a beverage container 1 that can be easily held by a single hand by an unassisted person who has limited fine motor skills. As shown in FIGS. 1 to 3, the beverage container 1 has first and second handle portions 2, 3 and a body member 4, including a cylindrical sidewall 5 and a base 6 having a substantially flat bottom surface 7.

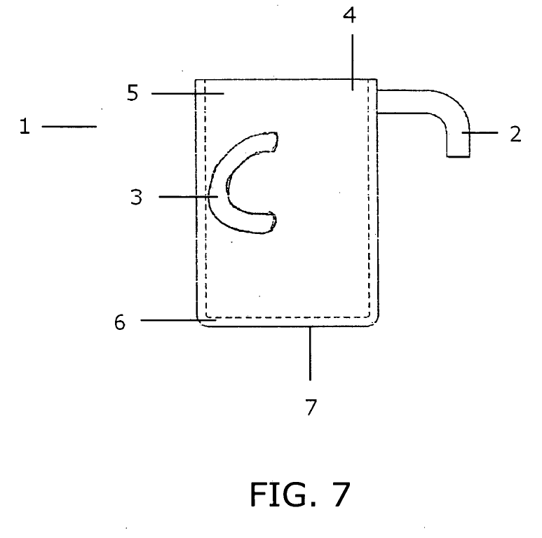

Both the first and second handle portions 2, 3 protrude from the cylindrical sidewall 5 of the body member 4 of the container 1. However, the first handle portion 2 is spaced apart from the second handle member 3. The first handle member 2 is generally larger than the second handle member 3 because the first handle member is adapted to engage with a user's fingers whilst the second handle member is generally adapted to engage only with the user's thumb. The first handle member 2 can be adapted to receive and engage with any number of the user's fingers (i.e. one, two, three or four). Indeed in an alternative embodiment of the invention shown in FIG. 7, the first handle member 2 is substantially L-shaped, having an open side edge, which further increases the ease with which the container 1 can be picked up and held by the user.

To facilitate the user holding the beverage container 1, the first and second handle members 2, 3 are orientated to allow the user to comfortably pick up and hold the container with a single hand without the need to grip the sidewall 5 of the body member 4 or the first or second handle members 2, 3. The location of the first and second handle members 2, 3 can therefore be placed in any location relative to each other to facilitate this action. Thus, the distance between the first and second handle members 2, 3 is not static and the second handle can be placed at any angle between 0° and 180° relative to the first handle member and with respect to the substantially flat bottom surface 7 of the base 6 of the body member 4.

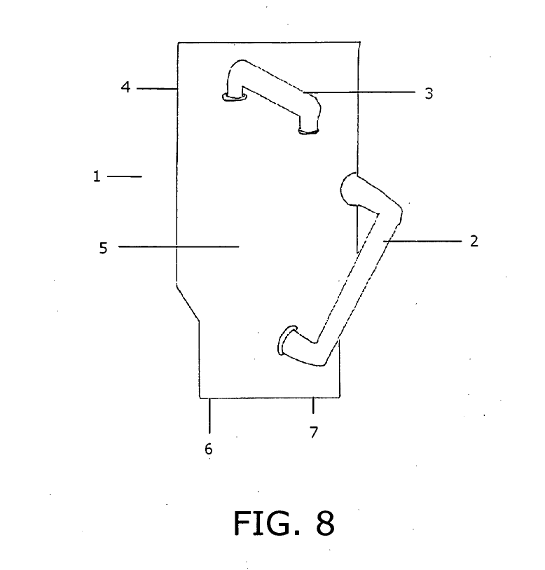

An alternative embodiment of the container 1 of the present invention is shown in FIG. 8, where the first handle member 2 is positioned on the sidewall 5 at an angle other than being substantially perpendicular to the flat bottom surface 7. As is clearly demonstrated in this embodiment, both the first and second handle members 2, 3 can be placed at any angle between 0° and 180° relative to the substantially flat bottom surface 7 of the base 6 of the body member 4.

It should be understood that the orientation of the first and second handle members 2, 3 can be of any suitable configuration, and can be suited for use with a user's left or right hand. The orientation of the first and second handle members 2, 3 can be tailored to suit individual user's specific needs, to provide a container 1 that can be picked up and held comfortably by all users.

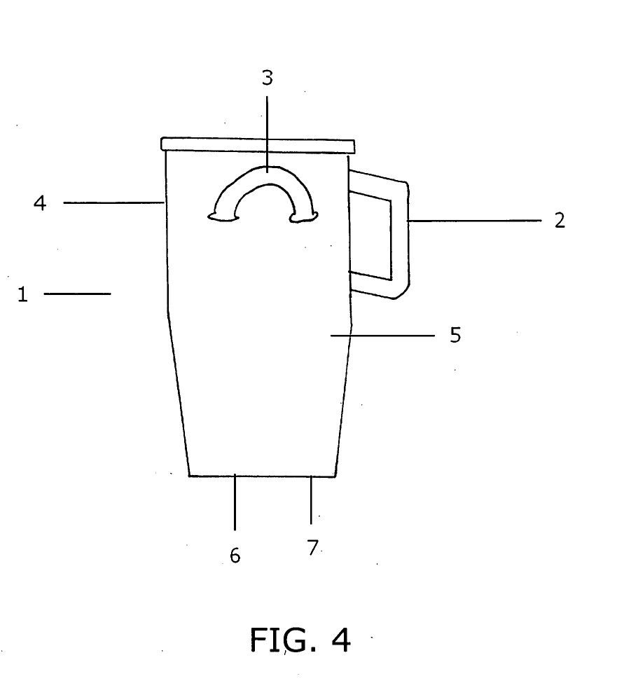

FIG. 4 shows an additional alternative embodiment of the container 1 of the present invention where the second handle member 3 is located in an alternative position relative to both the base 6 and the first handle member 2. In this embodiment, the bottom portion of the body member 4 is tapered and the first handle member 2 is of a different appearance to the handle members shown in FIGS. 1 to 3.

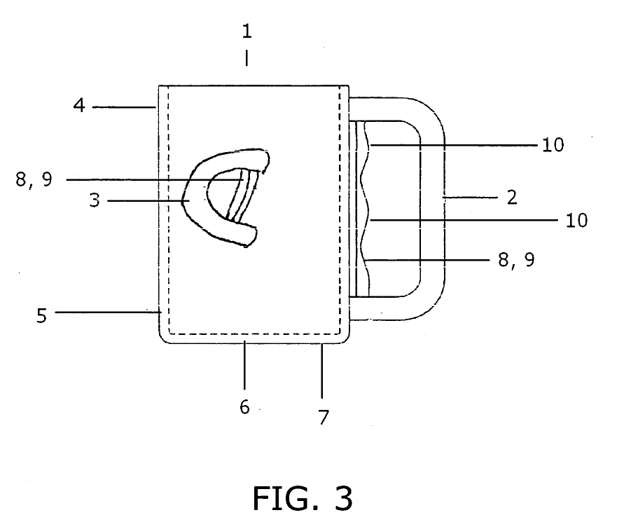

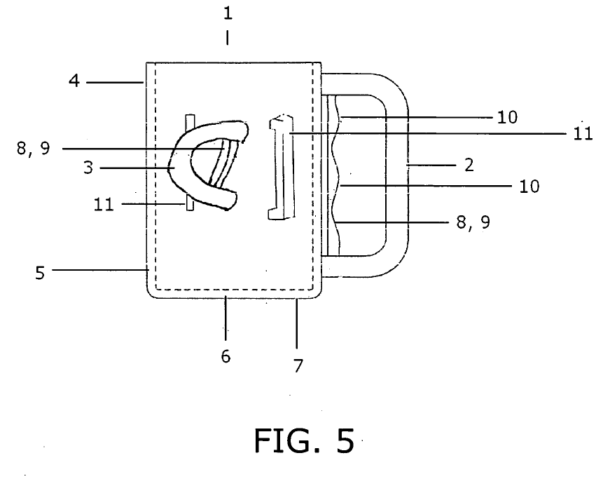

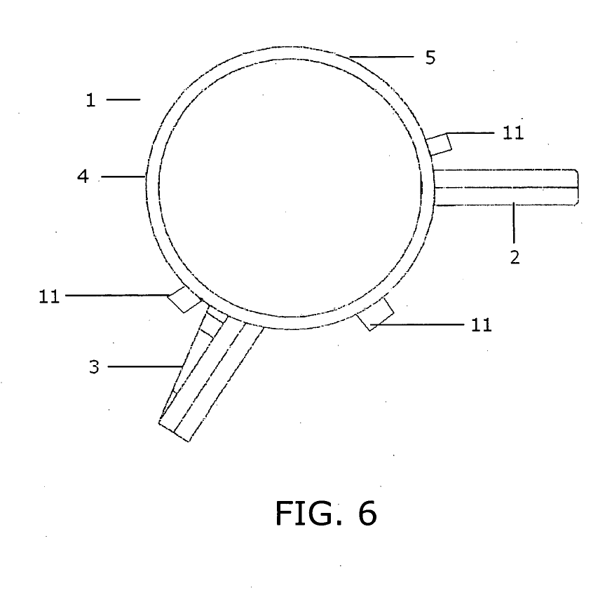

As shown in FIG. 3, the first and second handle members 2, 3 may also include thermal insulating material 8 in the form of heat insulation pads 9. The heat insulation pads 9 preferably include a plurality of heat transfer ridges 10 thereon. These ridges 10 also provide a contoured, ergonomic support for the user's fingers, particularly with the first handle member 2. The heat insulation pads 9 prevent contact between the user's fingers and thumb and the sidewall 5 of the body member 4. This is particularly useful where the beverage container 1 is used to carry hot drinks such as tea, coffee or the like that cause the sidewall 5 to become hot to the touch. To further reduce the possibility of the user inadvertently burning their hand, fingers and/or thumb, as shown in FIGS. 5 and 6, the sidewall 5 may include a plurality of heat insulation bars 11 also made of the thermal insulating material 8 to prevent contact between the user's palm and the sidewall.

The inclusion of the thermal insulating material 8 is particularly useful where the body member 4 of the container 1 is made of a thermally conductive material, such as food grade glass, metal, porcelain, waxed cardboard or the like. It is therefore preferred that the body member 4 be substantially made of an insulated material such as double-layer stainless steel, thermally insulative plastic or other similar materials.

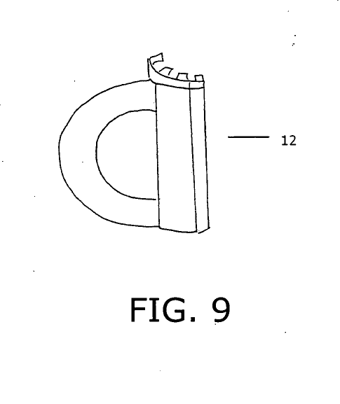

The present invention also relates to a support aid that can be retrofit to a conventional beverage vessel to form a beverage container 1 that can be easily picked up and held by an unassisted person having limited fine motor skills. As shown in FIG. 9, the support aid 12 is a handle member in accordance with the second handle member 3 shown in FIGS. 1 to 8. The support aid 12 can be adhered to a conventional cup or mug at a position that will allow the cup to be easily picked up and held by an unassisted person having limited fine motor skills. In this way, the support aid 12 should be fixed to the sidewall 5 of the cup at a position where the user's thumb will engage with the support aid and allow the cup to be easily picked up and held without the need to grip either the sidewall 5 or the fist and second handle members 2, 3.

Whilst the embodiments of the beverage container 1 shown in the accompanying drawings are adapted to be picked up and held by an unassisted person by engaging their fingers with the first handle member 2 and their thumb with the second handle member 3, it should be understood that other similar arrangements also fall within the scope of this invention. For example, by positioning the first and second handles 2, 3 in such proximity that a person can engage a first part of their fingers with the first handle member and a second part of their fingers with the second handle member, then the beverage container 1 can be utilized by people who may not have an opposable thumb.

The invention can be utilized in connection with a beverage container or drinking vessel that can be easily held by a person without the need to grip any part of the container.

The word “comprising”, or similar words, is generally intended to be interpreted in an inclusive sense, rather than exclusively, unless specifically indicted otherwise, and would normally allow other examples or features to be included.

It will be apparent that obvious variations or modifications may be made in accordance with the spirit of the invention that are intended to be part of the invention, and any such obvious variations or modification are therefore within the scope of the invention.

What is claimed is:

1. A beverage container comprising:
a body member having a circumferential sidewall and a base with a substantially flat bottom surface;
a first handle member protruding from the sidewall adapted to engage with a first portion of a user's first hand; and
a second handle member spaced apart from the first handle member and protruding from the sidewall adapted to engage with a second portion the first hand.

2. The beverage container of claim 1 wherein the second handle member is adapted to engage with a portion of the user's thumb.

3. The beverage container of claim 1 wherein the second handle member can be at any angle between 0° and 180° relative to the base.

4. The beverage container of claim 1 wherein the first handle member can be at any angle between 0° and 180° relative to the base.

5. The beverage container of claim 1 wherein the first and second handle members further include thermal insulating material to minimize heat transfer between the body member and the user's hand.

6. The beverage container of claim 5 wherein the thermal insulating material is a heat insulation pad having a plurality of heat transfer ridges.

7. The beverage container of claim 1 wherein the sidewall of the body member includes a plurality of heat insulation bars projecting therefrom.

8. The beverage container of claim 7 wherein each of the plurality of heat insulation bars are located on the sidewall for preventing contact between the user's hand and the sidewall of the body member.

9. The beverage container of claim 1 wherein the body member comprises substantially of one or more of food grade metal, plastic, ceramic, glass or clay.

10. The beverage container of claim 1 wherein the first handle member and the second handle member protrude from the sidewall for engagement by either the user's left hand or right hand.

11. A method of retrofitting a support aid to a beverage container comprising a body member having a circumferential sidewall, a base and a first handle member protruding from the sidewall, said first handle member for engagement with a first portion of a user's hand, said method comprising the steps of fixing a second handle member to the sidewall of the body member, said second handle member being adapted to be fixedly engaged with the sidewall at a location spaced apart from the first handle member and for engaging with a second portion the user's hand.

12. The method of claim 11 further providing a thermal insulating material on the second handle member to minimize heat transfer between the body member and the second portion of the user's hand.

13. The method of claim 11 wherein the step of fixing a second handle member to the sidewall of the body member includes adhering the second handle member to the sidewall of the body.

14. The method of claim 11 further providing for the second handle member being adapted to engage with a portion of the user's thumb.
